(19) United States
(12) Patent Application Publication
(10) Pub. No.: US 2012/0050520 A1
(43) Pub. Date: Mar. 1, 2012

(54) Method and Apparatus for Anti-Biofouling of Optics in Liquid Environments

(75) Inventors: Matthew D. Thoren, Tyngsboro, MA (US); Andrew M. Piper, Nashua, NH (US)

(73) Assignee: Raytheon Company, Waltham, MA (US)

(21) Appl. No.: 12/862,084

(22) Filed: Aug. 24, 2010

(51) Int. Cl. H04N 7/18; G21G 5/00

(52) U.S. Cl. 348/81; 250/492.1; 348/E07.085

(57) ABSTRACT

The present invention provides an apparatus and a method to prevent biofouling of underwater optical systems using ultraviolet light generated from within a pressure vessel and through an optics window, without removing the optical systems from the water and without disbursement of chemicals into the water.

### FIELD OF THE INVENTION

This invention relates generally to optical apparatus and, more particularly, to an apparatus, system, and method for keeping free of biological fouling an optical system immersed in a liquid, for example, the ocean.

### BACKGROUND OF THE INVENTION

There is a desire for optical sensors that can be used in liquids, for example, in the ocean, for long periods of time. Underwater objects, particularly underwater objects that are in the water for long periods of time, have external surfaces that are subject to so-called “biofouling.” A used herein, the term “biofouling” is used to describe an attachment of organisms that live in the liquid, e.g., in the ocean, to surfaces, particularly to man-made surfaces. The organisms can be small, for example, algae, or larger, for example, barnacles.

Detrimental effects of biofouling to man-made surfaces are well known and wide-ranging. Underwater optical systems have an optics window though which light must pass in order to generate optical images. Biofouling of the optics window can greatly reduce the quality of images generated by the underwater optical system.

As is known, some types of coatings, for example, anti-biofouling paints, can be applied to some surfaces, for example, ship hulls, to prevent or retard biofouling. However, anti-biofouling coatings tend to be opaque to the transmission of light, and therefore, tend not to be suitable to coat an optics window.

Therefore, in general, underwater optical systems must be removed from the water for cleaning of the optic optics window from time to time, and too often in the case of some underwater optical systems.

Copper corrosion mechanisms or Tributyltin (TBT) biocide leaching are known. Electro-chlorination systems and automatic acid (e.g. tin dioxide) dispensing systems are also known. These mechanisms require release of chemicals into the water, proximate to an outside surface of an optics window. These mechanisms prevent biofouling on optical surfaces through localized production of bleach, via an oxidation of chloride ions present in seawater. Although the effects of such chemical systems are temporary, only lasting a few months, the effect on the environment is larger than desired for an anti-biofouling system. Furthermore the chemical release mechanisms are subjected to the ocean environment, e.g., pressure, resulting in reduced reliability.

Ultraviolet (UV) radiation consists of electromagnetic radiation between visible violet light and x-rays, and ranges in wavelength from about 400 nm to about 10 nm. UV is a component (less than 5%) of the sun's radiation and is also produced artificially by arc lamps, e.g., by a mercury arc lamp (or mercury vapor lamp).

Ultraviolet radiation in sunlight is often considered to be divided into three bands. Ultraviolet light in a UVA band (about 320-400 nm) can cause skin damage and may cause melanomatous (skin cancer). Ultraviolet light in a UVB band (about 280-320 nm) is stronger radiation that increases in the summer and is a common cause of sunburn and most common skin cancer. Ultraviolet light in a UVC band (below about 280 nm) is the strongest, having the greatest energy per photon (eV), and is potentially the most harmful form. Photon energy is calculated using: E=hv=he/λ, where h is Plancks Constant, c is the speed of light, and λ is wavelength. Therefore, the lower the wavelength of electromagnetic radiation, the greater the energy per photon.

Much of the UVB radiation and most of the UVC radiation is absorbed by the ozone layer of the atmosphere before it can reach the earth's surface. Much of the UVB and UVC radiation that does pass through the ozone layer tends to be partially absorbed by ordinary window glass or by impurities in the air (e.g., water, dust, and smoke).

Ultraviolet germicidal irradiation (UVGI) is a sterilization method that uses specific UVC wavelengths (about 253.7 nm) to break down and kill microorganisms. Wavelengths of UVC radiation at or near 253.7 nm are known to be effective in destroying nucleic acids in the microorganisms so that their DNA is disrupted. Disruption of the DNA eliminates reproductive capabilities and kills the microorganisms.

U.S. Pat. No. 5,322,569, issued Jun. 21, 1994, describes an ultraviolet generating mechanism that can prevent biofouling underwater.

It would be desirable to provide means to prevent biofouling of underwater optical systems, within and as part of the underwater optical systems, without removing the optical systems from the water, and without disbursement of chemicals into the water.

### SUMMARY OF THE INVENTION

The present invention provides an apparatus and a method to prevent biofouling of underwater optical systems, within and as part of the underwater optical systems, without removing the optical systems from the water and without disbursement of chemicals into the water.

In accordance with one aspect of the present invention, apparatus for imaging includes a pressure vessel having a port passing through the pressure vessel. The apparatus also includes an optics window covering the port. The apparatus also includes an ultraviolet light source disposed inside the pressure vessel and proximate to the optics window. The ultraviolet light source is configured to generate ultraviolet light that passes through the optics window and through the port. The ultraviolet light has a wavelength selected to kill or repel biological organisms outside of the pressure vessel proximate to the optics window.

In accordance with another aspect of the present invention, a method of imaging includes generating ultraviolet light inside of a pressure vessel that passes through an optics window and through a port passing through the pressure vessel. The ultraviolet light has a wavelength selected to kill or repel biological organisms outside of the pressure vessel proximate to the optics window.

### BRIEF DESCRIPTION OF THE DRAWINGS

The foregoing features of the invention, as well as the invention itself may be more fully understood from the following detailed description of the drawings, in which:

FIG. 1 is a pictorial showing an underwater pressure-sealed imaging assembly used in a plurality of different optical imaging system arrangements;

FIG. 2 is a perspective drawing showing a pressure-sealed imaging assembly having an imaging assembly therein that includes an imaging camera, imaging lights, and anti-biofouling lights, all inside a pressure vessel that has two optical ports;

FIG. 3 is a block diagram showing a laser line scan system (LLSS) that can be used as the imaging assembly of FIG. 2, wherein the LLSS has a laser that can form one of the imaging lights of FIG. 2;

FIG. 4 is side view of a pressure vessel having two optical ports that can form the pressure vessel of FIG. 2;

FIG. 5 is a cross-sectional view of the pressure vessel of FIG. 4 taken along a section line D-D, which shows the pressure vessel (pressure housing), an optics window, a port, an internal housing, and a light emitting diode (LED) array, which LED array can be one of the anti-biofouling lights of FIG. 2;

FIG. 6 is a perspective drawing showing the elements of FIG. 5;

FIG. 7 is a block diagram showing an LED array that is the same as or similar to the LED array of FIGS. 5 and 6, and showing light beams transmitted therefrom;

FIG. 8 is a block diagram showing an imaging assembly as may be the imaging assembly of FIG. 2, having an imaging camera and an imaging processor and also, in some embodiments, having an image recognition processor and a detection processor, and also having an anti-biofouling light source as may be the anti-biofouling lights of FIG. 2, and an imaging light source as may be the imaging lights of FIG. 2;

FIGS. 9-15 are graphs showing transmission of ultraviolet light through a variety of materials used for optical windows in pressure-sealed imaging assemblies configured to operate in liquid environments; and

FIG. 16 is a graph showing transmission of ultraviolet light through water.

### DETAILED DESCRIPTION OF THE INVENTION

Before describing the present invention, some introductory concepts and terminology are explained. As used herein, the term “optical system” is used to describe any system capable of generating an optical image upon any medium, including, but not limited to, film, paper, and digital media. An optical system can include a variety of components, for example, a radio transmitter and/or a computer. As used herein, the term “imaging assembly” is used to describe an image-generating portion of an optical system, including an “imaging camera” and light sources. As used herein, the term “pressure-sealed imaging assembly” is used to describe an imaging assembly disposed in and including a pressure vessel. A pressure-sealed imaging assembly can be a part of an optical system.

It should be noted that reference is sometimes made herein to assemblies having a particular shape (e.g., cylindrical). One of ordinary skill in the art will appreciate, however, that the techniques described herein are applicable to a variety of sizes and shapes.

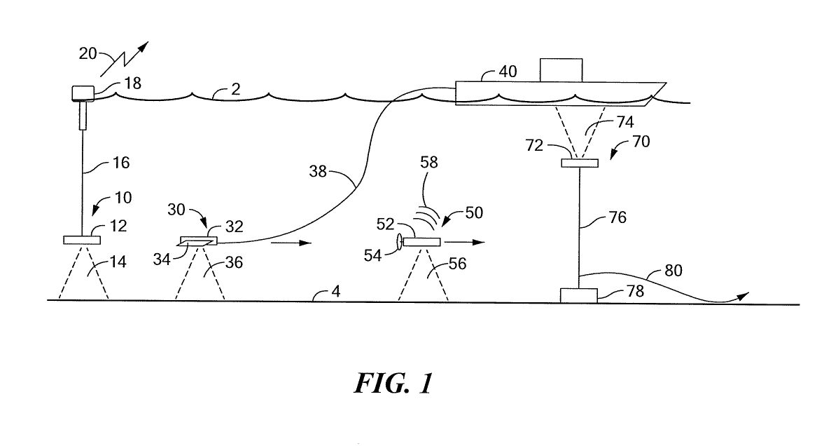

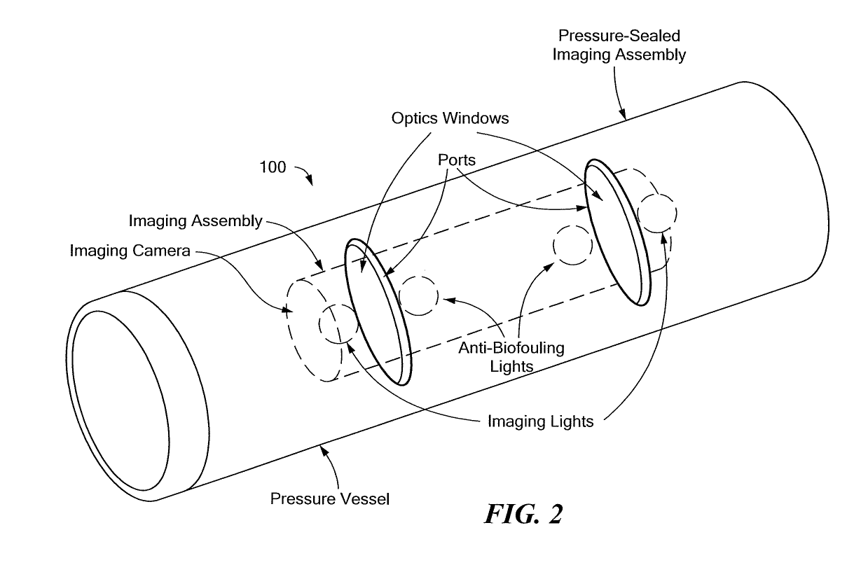

Referring now to FIG. 1, a first optical system 10 includes a pressure-sealed imaging assembly 12, an example of which is described more fully below in conjunction with FIG. 2. The pressure-sealed imaging assembly 12 is configured to receive imaging light 14 in order to generate an optical image of a bottom 4 of a body of water or an object on or near the bottom 4, for example, a mine, as the first optical system 10 drifts in the water.

The first optical system 10 can include a suspension system 16, which can include a communication link, for example, a wire or a fiber optical cable. The pressure-sealed imaging assembly 12 can communicate one or more images up the communication link 16 to a surface float 18 to which the pressure-sealed imaging assembly 12 and suspension system 16 are coupled. The surface float 18 can include a transmitter, for example, a radio frequency (RF) transmitter, configured to transmit RF electronic data 20 representative of the optical images generated by the pressure-sealed imaging assembly 12. The RF electronic data 20 can be received by in information destination, for example, an aircraft, a ship, or a shore station that includes an RF receiver. The RF receiver can be configured to receive the RF electronic data 20 and configured to regenerate the optical images from the received RF electronic data 20.

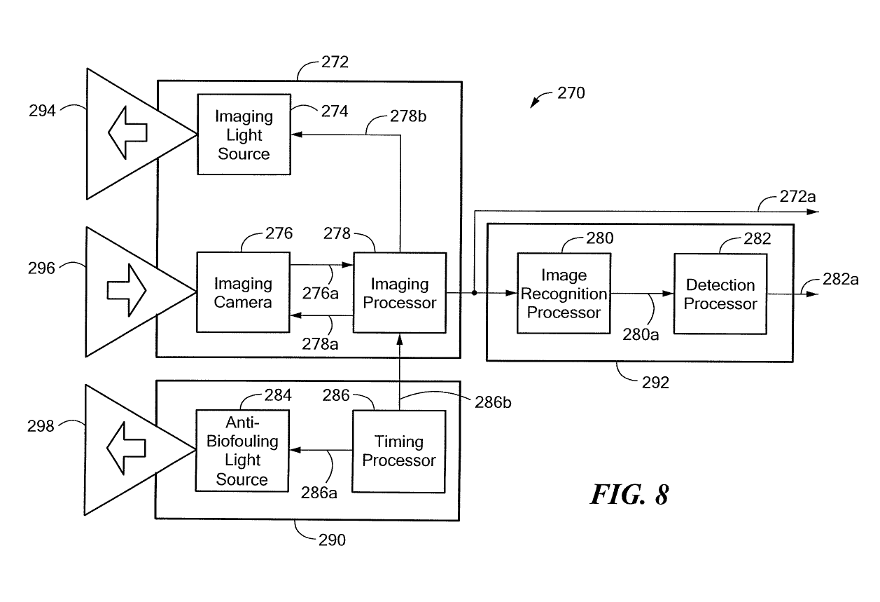

In some embodiments, the information destination also includes one or more processors configured to analyze the optical images. For example, the information destination can include an image recognition processor configured to analyze the optical images to identify particular image characteristics. The identified image characteristics can include, for example, an identified moving object, for example a submarine, or a fish. The identified image characteristics can include, for another example, characteristics of an identified stationary object, for example, a round shape as may indicate a mine. The image recognition processor is also described below in conjunction with FIG. 8.

The information destination can also include a detection processor coupled to receive the indentified characteristics and configured to further analyze the image data, for example, to generate data associated with the identified characteristics. For example, the detection processor can generate an accumulated count of fish that are identified. For another example, the detection processor can detect a mine. The detection processor is also described below in conjunction with FIG. 8.

A second optical system 30 includes a pressure-sealed imaging assembly 32, which can be the same as or similar to the pressure-sealed imaging assembly 12, but which can include fins 34 or other features configured to stabilize the pressure-sealed imaging assembly 32 as it is towed through the water by a ship 40 via a tow and communication cable 38. The pressure-sealed imaging assembly 32 is configured to receive imaging light 36 in order to generate optical images of the bottom 4 of the body of water or an object on or near the bottom 4, for example, a mine, as the optical system 30 is towed through the water.

The tow and communication cable 38 can include a communication link, for example, a wire or a fiber-optic cable. The pressure-sealed imaging assembly 32 can communicate one or more images up the tow and communication cable 38 to the ship 40.

The ship 40 can have aboard the ship 40 the information destination, which can include one or more processors configured to analyze the optical images as described above.

A third optical system 50 includes a pressure-sealed imaging assembly 52, which can be the same as or similar to the pressure-sealed imaging assembly 12, but which can include a propulsion system 54 configured to propel the pressure-sealed imaging assembly 52 through the water. The pressure-sealed imaging assembly 52 is configured to receive imaging light 56 in order to generate optical images of the bottom 4 of the body of water or an object on or near the bottom 4, for example, a mine, as the optical system 50 is propelled through the water.

The third optical system 50 can include the elements of the information destination described above. In some embodiments, the third optical system 50 can transmit a sound signal 58 that can include the optical images, the indentified characteristics of the optical images, or the further processed image data. The sounds signal 58 can be received by a hydrophone (not shown), which can be at the ship 40.

A fourth optical system 70 includes a pressure-sealed imaging assembly 72, which can be the same as or similar to the pressure-sealed imaging assembly 12, but which is upward looking. The pressure-sealed imaging assembly 72 is configured to receive imaging light 74 in order to generate optical images of a surface 2 of the body of water or an object on or near the surface 2, for example, a ship, or fish. The pressure-sealed imaging assembly 72 can be tethered through a tether and communication cable 76 to an anchor 78 disposed on the bottom 4. A communication cable 80 can carry optical data to the above-described information destination. The fourth optical system 70 can transmit a signal through the communication cable 80 that can include the optical images, the indentified characteristics of the optical images, or the further processed image data.

Referring now to FIG. 2, a pressure-sealed imaging assembly 100 can include a pressure vessel having structural characteristics and material characteristics selected to allow the pressure vessel to survive a liquid environment having pressure (e.g., depth) and liquid chemical properties (e.g., salt). In some arrangements, the pressure vessel is configured to survive in the ocean, a corrosive and high-pressure environment, for substantial periods of time, for example, months or years. In some arrangements, the pressure vessel is designed to survive depths of at least one of five hundred feet, one thousand feet, five thousand feet, ten thousand feet, twenty thousand feet, or thirty thousand feet. In some arrangements, the pressure vessel is designed to survive full ocean depths into the ocean trenches and beyond.

While ocean environments are described in examples herein, it should be understood that the same assemblies and techniques pertain to any liquid environment.

The pressure vessel can include one or more ports that provide respective openings through the pressure vessel. The one or more ports are filled (i.e., sealed) by a respective one or more optics windows, which are windows transparent to imaging light. In high-pressure environments, the optics windows are made from high strength materials.

The optics windows can be made from a variety of materials, including, but not limited to, glass, quartz (SiO₂), including crystal or commercial grades of quartz, fused silica (SiO₂), including UV or IR grades of fused silica, calcium fluoride (CaF₂), magnesium fluoride (MgF₂), or sapphire (Al₂O₃).

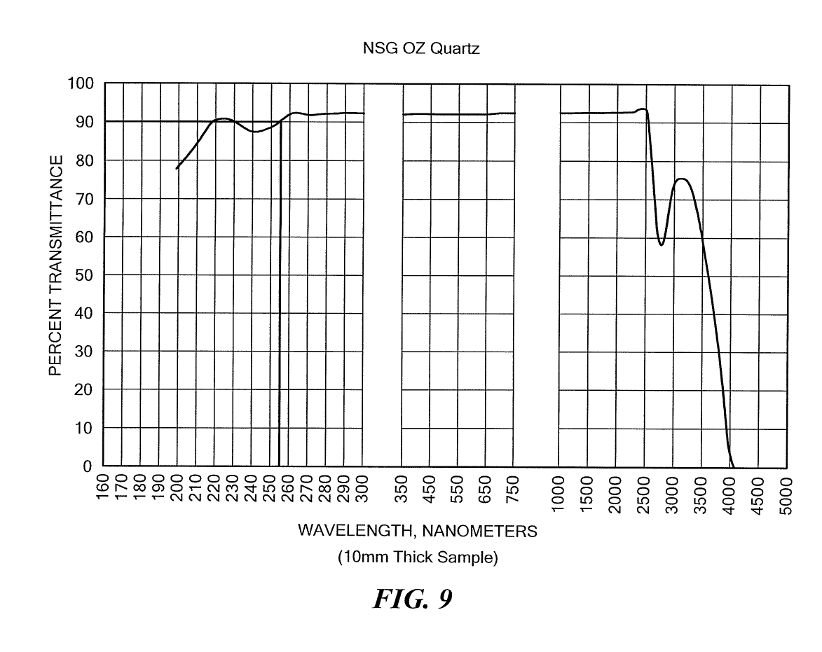

Each of the materials above allows transmission of light having wavelengths suitable for optical imaging in the visible part of the light spectrum (a wavelength range from about 380 or 400 nm to about 760 or 780 nm). In addition, each of the materials listed above allows transmission of light having wavelengths in the ultraviolet part of the light spectrum, in particular, light having a wavelength of about 250-260 nm in the UVC range of the ultraviolet part of the light spectrum. UVC light transmission capabilities are shown in FIGS. 9-15. As described above, UVC light can provide ultraviolet germicidal irradiation (UVGI).

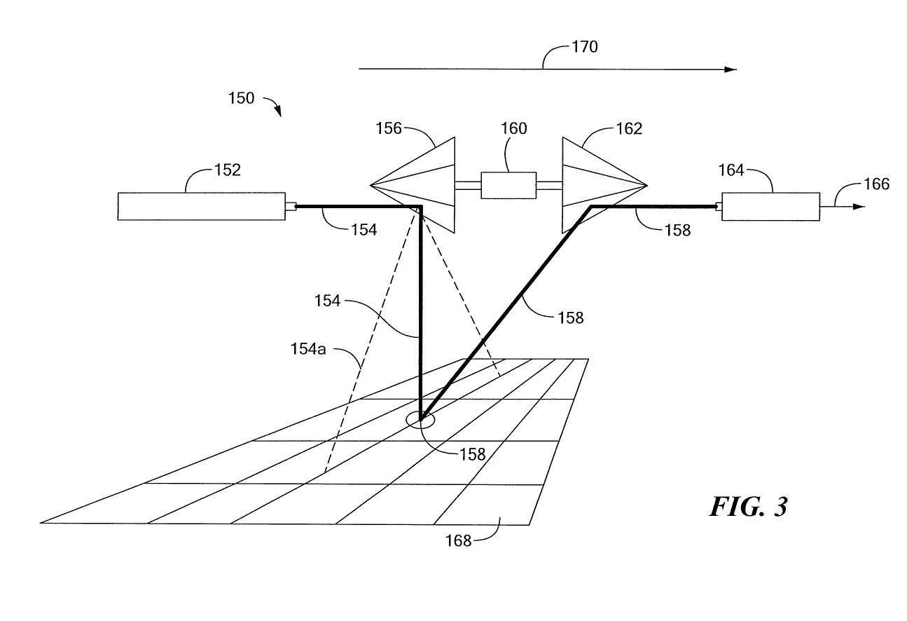

The pressure-sealed imaging assembly can include an imaging assembly disposed within an inner volume of the pressure vessel. The imaging assembly can include and imaging camera. The imaging camera can be, but is not limited to, a film still camera, a film movie camera, a digital still camera, a digital video camera, or a laser line scan system (LLSS). The LLSS is described more fully below in conjunction with FIG. 3.

The imaging assembly can also include one or more imaging lights disposed within the inner volume of the pressure vessel and proximate to the optics windows so as to provide light that shines outside of the pressure vessel and that can reflect from objects outside of the pressure vessel to contribute to a optical image captured by the imaging assembly. In some embodiments, the imaging assembly includes no imaging lights and the optical image is generated instead by way of ambient light in the environment, for example, sunlight that penetrates into the ocean.

It will be understood that sunlight does not propagate very far in seawater. It will also be understood that different colors in sunlight tend to propagate different distances in seawater. For example, most of the red and yellow portions of sunlight tend to propagate less than about twenty feet in seawater, leaving blues at greater depths or distances. Thus, in many applications, it is advantageous to have the imaging lights.

The imaging assembly can also include one or more anti-biofouling lights disposed within the inner volume of the pressure vessel and proximate to the optics windows. In operation, the anti-biofouling lights generate continuously or from time to time ultraviolet light having an intensity and a wavelength selected to kill or to repel liquid borne (e.g., marine) organisms that would tend to accumulate and live upon the optics windows. In some embodiments, the anti-biofouling lights generate UVC light. However, in other embodiments, the anti-biofouling lights can generate light having wavelengths in the UVA of UVB parts of the ultraviolet spectrum.

It will be understood that the material of the optics windows must be selected to transmit both imaging light (e.g., visible light) and also the light generated by the anti-biofouling lights (e.g., ultraviolet light).

UVC light is known to be strongly absorbed by air. Thus, if the pressure vessel were filled with air, there may be substantial transmission loss of ultraviolet light generated by the anti-biofouling lights as it propagates from the anti-biofouling lights to the optics windows. However, the pressure vessel can be filled with a gas other than air, for example, nitrogen, which provides excellent transmission of the UVC light from the anti-biofouling lights to the optics windows.

UVC radiation for ultraviolet germicidal irradiation (UVGI) is conventionally generated using mercury vapor lamps. Mercury vapor lamps have size and power requirements undesirable for use within the pressure vessel used underwater for long periods of time. However, in some embodiments the anti-biofouling lights are mercury vapor lamps. In other embodiments, the anti-biofouling lights are comprised of one or more UV lasers, for example, excimer lasers.

Light emitting diodes (LEDs) that can transmit ultraviolet light in the UVA, UVB, and UVC parts of the ultraviolet spectrum are recently available. In particular, UV LEDs (e.g., AlInGaN LEDs) are recently available with appropriate sizes and that can transmit UVC with sufficient intensities and efficiencies to provide the anti-biofouling lights inside of the pressure vessel used underwater for long periods of time. Thus, in some embodiments, the anti-biofouling lights are each comprised of one or more UV LEDs.

In some embodiments, the anti-biofouling lights transmit UVC light having an intensity of about twenty μW per square centimeter at the outer surface of the optics windows. However, the intensity can be more than or less than twenty μW per square centimeter, for example, within a range of about ten to about thirty μW per square centimeter. The intensity of the UVC light can be selected in accordance with a variety of factors, for example, a temperature of the water, a type of the water (e.g., fresh or salt water), or a type of organism (e.g., barnacles) for which anti-biofouling is desired (e.g., barnacles).

In some embodiments, the anti-biofouling lights transmit UVC light having a wavelength of about 254 nm with a total power of about 1200 μW, for an optics window having an outer surface area of about 9.3 square inches (60 square centimeter), resulting in the above-described nominal value of twenty μW per square centimeter. In order to accomplish this intensity from each of the anti-biofouling lights, each one of the anti-biofouling lights may be comprised of a plurality of UV LEDs, for example eight UV LEDs, each transmitting UVC light having a wavelength of about 254 nm with a power of about 150 to 300 μW. However, more than or fewer than eight UV LEDs can be used, with powers adjusted accordingly, in order to achieve the above described intensity of about ten to about thirty μW per square centimeter. In some alternate embodiments, the anti-biofouling lights have a wavelength in the range of about two hundred forty to about two hundred sixty nanometers.

The UV LEDs are known to have optical beam widths ranging from about zero to about one hundred twenty degrees. Therefore, a number and a spacing of UV LEDs is selected to form each one of the anti-biofouling lights to provide a fairly uniform intensity of ultraviolet light over an outer surface of the optics windows, where organisms might otherwise tend to attach.

In some embodiments, since they are small, the UV LEDs can be retrofitted into an existing pressure-sealed imaging assembly.

Referring now to FIG. 3, a conventional laser line scan system (LLSS) 150 can form the imaging assembly of FIG. 2 (anti-biofouling lights not shown).

The LLSS 150 can include a solid state laser 152 configured to project a beam 154 of laser light onto a first rotating faceted mirror 156, rotated by a motor 160, resulting in a swept beam 154, 154a of laser light that exits the LLSS 150 and that sweeps a spot 158 in a line across a surface 168 to be imaged.

A second rotating faceted mirror 162, rotated by the motor 160, receives light 158 having reflected from the surface 168 and provides a swept line image to a digital imaging device 164. From a plurality of line images resulting from a corresponding plurality of sweeps of the laser light 154 as the LLSS 150 moves in a direction represented by an arrow 170, the LLSS 150 can generate an image 166 of the surface 168, including objects on or proximate to the surface 168.

It will be apparent that the conventional LLSS 150 uses two light paths, one to transmit the laser light 154 and one to receive the reflected light 158. Thus, the pressure-sealed imaging assembly of FIG. 2 has two optics windows, one through which imaging light can be transmitted and one through which reflected light can be received.

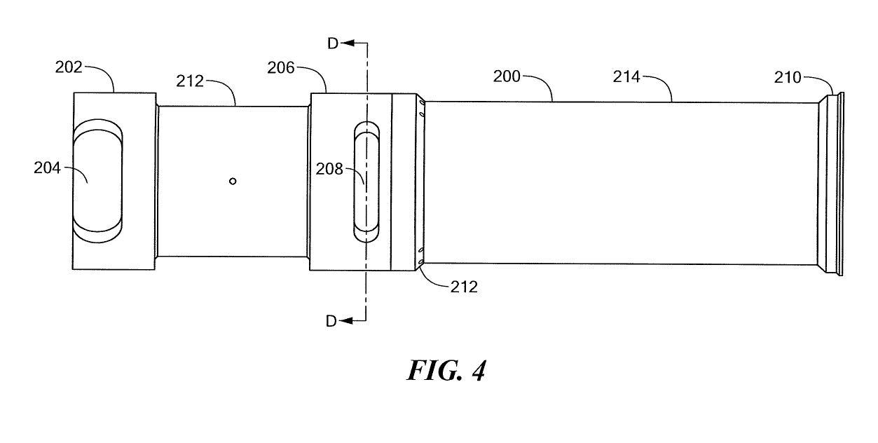

Referring now to FIG. 4, a pressure-sealed imaging assembly of the types described above can include a pressure vessel 200 having a first portion 202 with a first port 204 and a second portion 206 having a second port 208. The first and second portions 202, 206, respectively, can be coupled with a first cylindrical portion 212. A second cylindrical portion 214 can couple to the second portion 206 of the pressure vessel 200 at a flange 212 with bolts or the like (not shown). An end cap 210 can seal an end of the second cylindrical portion 214. The first portion 202 of the pressure vessel 200 can couple to other portions of the pressure vessel 200 that are not shown.

In some embodiments, the first port 204 is used to receive imaging light from a laser line scanning system (LLSS), for example, the LLSS of FIG. 3, disposed within the pressure vessel 200, and the second port 208 is used to transmit source (laser) light from the LLSS. However, in other embodiments, there can be only one port and the source light can be generated and the imaging light can be received through the one port.

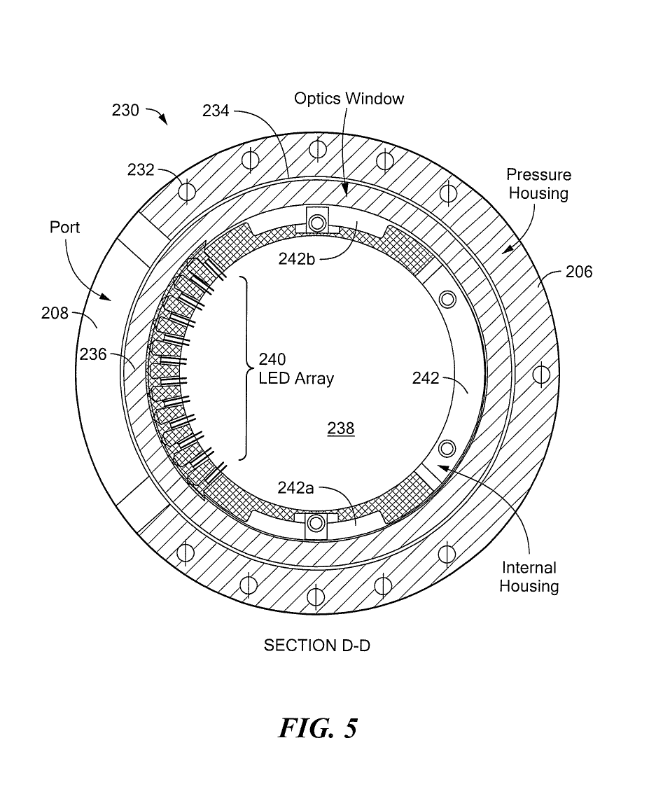

Referring now to FIG. 5, in which like elements of FIG. 4 are shown having like reference designations, a cross-sectional view along the line D-D of FIG. 4 shows the second portion 206 of the pressure vessel 200 (pressure housing) having the port 208 of FIG. 4.

An optics window 236 is disposed inside of the second portion 206 of the pressure vessel 200 and proximate to the port 208. The second portion can include bolt holes, of which a bolt hole 232 is representative. The bolt holes provide coupling to the flange 212 of FIG. 4

The optics window 236 can be cylindrical with a portion of the optics window allowing light to pass through the port 208 and another portion of the optics window coupled to an inside surface of the second portion 206 of the pressure vessel at a joint 234. In some embodiments, the joint 234 is filled with an adhesive, for example, an epoxy, for sealing the optics window 236 from liquid intrusion.

In some alternate embodiments, the optics window 236 covers only the port 208 and a smaller portion beyond the port 208 and is joined to the inner surface of the second portion 206 of the pressure vessel 200 with the adhesive.

An internal housing 242 can be used to mount an LED array 240, for example a plurality of UV LEDs, within an inner volume 238 of the second portion 206 of the pressure vessel 200. The internal housing 242 can have passages 242a, 242b through which wires or other elements can pass.

In some embodiments, there are twelve LEDs in the LED array 240. However, in other embodiments, the LED array 240 can include more than or fewer than twelve LEDs, for example, eight LEDs.

While the LED array is shown in conjunction with the second portion 206 of the pressure vessel 200 of FIG. 4, it will be understood that there can be another LED array the same as or similar to the LED array 240 proximate to the first port 204 of FIG. 4.

An imaging camera and imaging lights, the same as or similar to the imaging camera and the imaging lights that form part of the imaging assembly of FIG. 2, can also be disposed within the pressure vessel. The LED array 240 can be the same as or similar to one of the anti-biofouling lights of FIG. 2. The port 208 can be the same as or similar to one of the ports of FIG. 2.

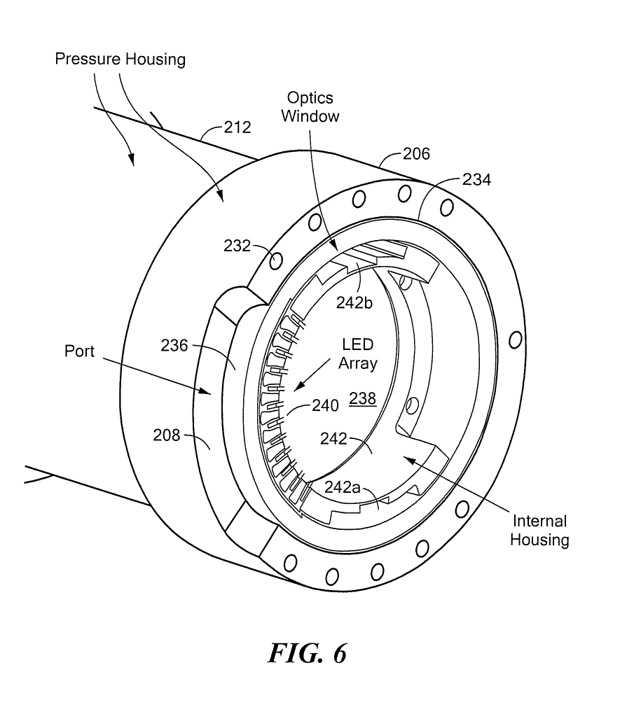

Referring now to FIG. 6, a perspective view along the line D-D of FIG. 4 shows the same elements as the cross section of FIG. 5, plus the first cylindrical portion 212 of FIG. 4. The elements of FIG. 6 will be understood from the discussion above in conjunction with FIGS. 4 and 5.

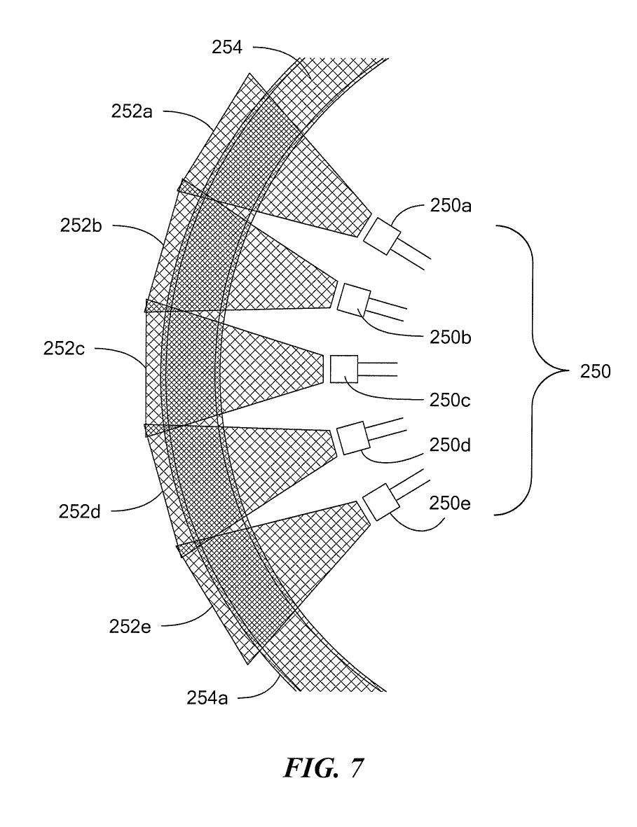

Referring now to FIG. 7, an LED array 250 can be the same as or similar to the LED array 240 of FIGS. 5 and 6. The LED array 250 is comprised of a plurality of LEDs 250a-250e, for example, UV LEDs, configured to generate UVC light having respective beampatterns 252a-252e.

The UVC light passes through an optics window 254, which can be the same as or similar to the optics window 236 of FIGS. 5 and 6, and, more particularly, through a portion of the optics window 236 proximate to the port 208 through which light can pass.

A number, spacing, and mounting angle of the LEDs is selected so that the beampatterns 252a-252e in combination cover all of or most of an outside surface 254a of the optics window. In some embodiments, there are five LEDs in the LED array 250. However, in other embodiments, the LED array 250 can include more than or fewer than five LEDs. In some embodiments, each LED has a beampattern spanning approximately one hundred twenty degrees. However, in other embodiments, each LED has a beampattern spanning more than or less than one hundred twenty degrees.

It will be appreciated that beampatterns can be influenced by a type of lens (e.g., flat window, ball lens, hemispherical lens, etc.) that forms a part of, or that can be used in conjunction with, the LEDs. Other embodiments can include ancillary optics to control beam patterns.

Referring now to FIG. 8, an imaging assembly 270 can be the same as or similar to the imaging assembly of FIG. 2. The imaging assembly 270 can include an imaging portion 272, an anti-biofouling portion 290, and a post-processing portion 292. It will be understood from discussion above in conjunction with FIG. 1, that, in some embodiments, the post-processing portion 292 can be disposed within the imaging assembly of FIG. 2, while in other embodiments, the post-processing portion 292 can be disposed at an information destination, for example, aboard the ship 40 of FIG. 1.

The imaging assembly 270 can include an imaging light source 274, for example, a laser line scanning light source as may be provided in a laser line scan system (LLSS) (see, e.g., FIG. 3). The imaging light source 274 can generate imaging light 294 either continuously or from time to time as optical images are generated.

The imaging assembly 270 can also include an imaging camera, for example, a laser line scanning camera as may be provided in a laser line scan system (LLSS) (see, e.g., FIG. 3). The imaging camera 276 is configured to receive light 296 reflected from or generated by an object to be imaged.

An imaging processor 278 is coupled to receive digital image data 276a from the imaging camera 276 and configured to generate optical images 272a (in digital form). The imaging processor 278 is also configured to generate a control signal 278a that can provide a variety of adjustments, for example, exposure adjustments and timing adjustments, to control the imaging camera 276. The imaging processor 278 is also configured to generate a control signal 278b that can provide a variety of adjustments, for example, light intensity adjustments and timing adjustments, to control the imaging light source 274.

The imaging assembly 270 can also include an anti-biofouling light source 284 configured to generate light 298 having a wavelength and an intensity selected to kill or to repel organisms. The anti-biofouling light source 284 can be the same as or similar to the anti-biofouling light sources of FIG. 2 or of the LED array 240 of FIGS. 5 and 6.

The imaging assembly 270 can also include a timing processor 286 configured to generate a control signal 286a that can provide a timing control of the anti-biofouling light source 284 in order to turn the anti-biofouling light source 284 on and off from time to time. It may be desirable, for example, to turn the anti-biofouling light source 284 off when the imaging camera 276 is generating an optical image. However it may also be desirable to turn the anti-biofouling light source 284 off for much of the time, as it may be possible to kill or to repel organisms using the anti-biofouling light source 284 for only short periods of time. Embodiments that provide duty cycles of light sources can increase the overall life of the imaging assembly 270 while maintaining sufficient anti-biofouling of optical ports.

In some embodiments, the anti-biofouling light source 284 can be turned on during generation of an image, wherein the UVC light does not interfere with the image generation. In some embodiments, the imaging assembly 270 can include an optical filter, which may be provided as part of the imaging camera 276, to block the ultraviolet light from the imaging light path.

The imaging assembly 270 (or an information destination) can include an image recognition processor 280 coupled to receive the optical images 272a and configured to generate a signal 280a representative of a characteristic of the optical images 272a.

The imaging assembly 270 (or an information destination) can include a detection processor 282 coupled to receive the signal 280a and configured to generate data 282a associated with the signal 280a.

In some embodiments, the signal 280s is representative of a characteristic of the image that comprises a count of objects in the image and the data 282a associated with the characteristic comprises an accumulated count of the objects. For example, the count of objects in the image can be a count of fish in the image and the data associated with the characteristic can be an accumulated count of the fish.

In some other embodiments, the signal 280a is representative of a characteristic of the image that comprises a shape of some subject matter in the image and the data 282a associated with the image comprises an identification of the subject matter, e.g., a mine.

The imaging assembly 270 can provide the optical images 272a and/or the data 282a to an information destination.

While some applications of the optical systems are described herein, it should be apparent that there are a vast number of other applications for optical systems that have pressure-sealed imaging assemblies with the above-described anti-biofouling lights disposed therein. For example, optical systems can be used to inspect the interior of pipes, either underwater liquid filled pipes, or land-based liquid filled pipes.

It will be understood that there has been a long felt but unresolved need to provide underwater optical systems that can remain in the water for extended periods of time without attention. Such long-term optical systems have suffered from bio-fouling. Thus, there has also been a long felt but unresolved need for a means to clean, without attention, the optical ports of the optical systems.

Prior UVC light sources (e.g., mercury vapor lamps) are large and require substantial amounts of power. LEDs that can transmit UVC light have only recently become available. Thus, only recently have small and low power UVC light sources become available that can fit inside of an underwater optical system.

FIGS. 9-15 each show a respective graph having a horizontal axis with a scale in units of wavelength of light in nanometers and a vertical axis with a scale in units of percent transmittance in percent. Each graph has a curve representative of transmittance of light through a respective optics window material that varies with light wavelength. On each graph is drawn a vertical line at a wavelength of about 255 nm, representative of a wavelength of UVC light, and a respective horizontal line at a percent transmittance where the vertical line intersects the curve.

Referring now to FIG. 9, the graph corresponds to transmittance of commercial grade quartz. The transmittance of light at about 255 nm is about ninety percent.

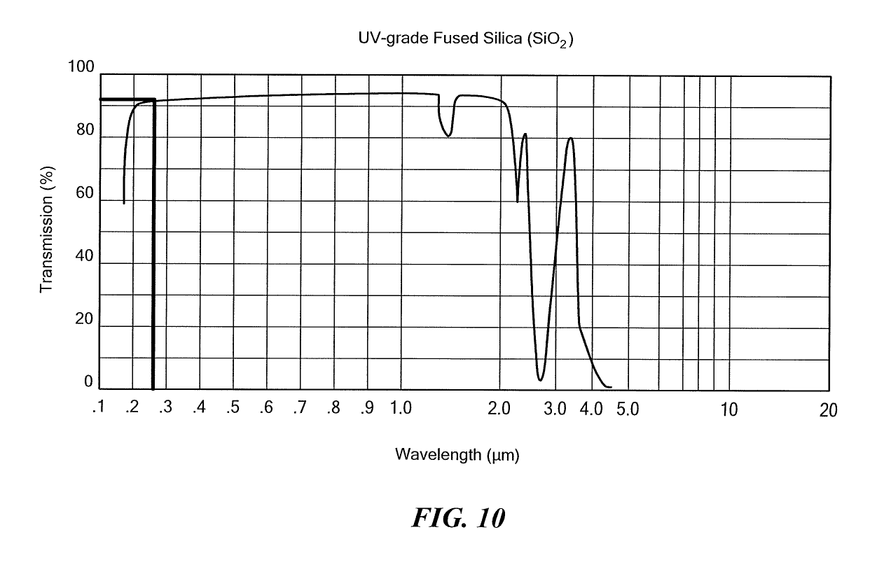

Referring now to FIG. 10, the graph corresponds to transmittance of UV-grade fused silica. The transmittance of light at about 255 nm is greater than ninety percent.

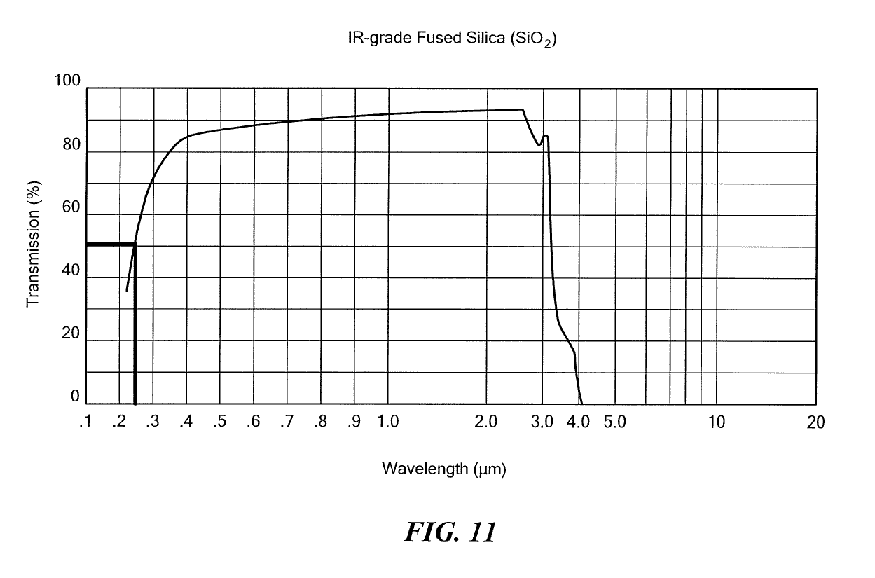

Referring now to FIG. 11, the graph corresponds to transmittance of IR-grade fused silica. The transmittance of light at about 255 nm is about fifty percent.

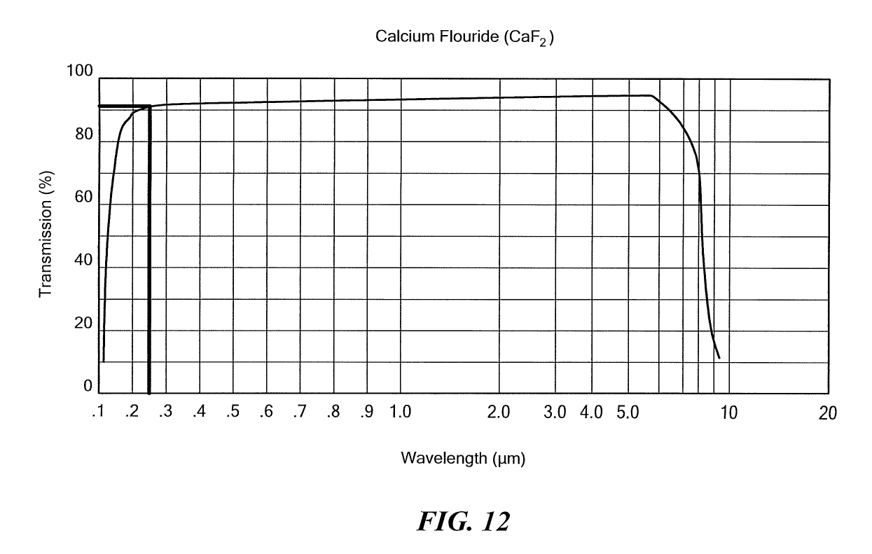

Referring now to FIG. 12, the graph corresponds to transmittance of calcium fluoride. The transmittance of light at about 255 nm is greater than ninety percent.

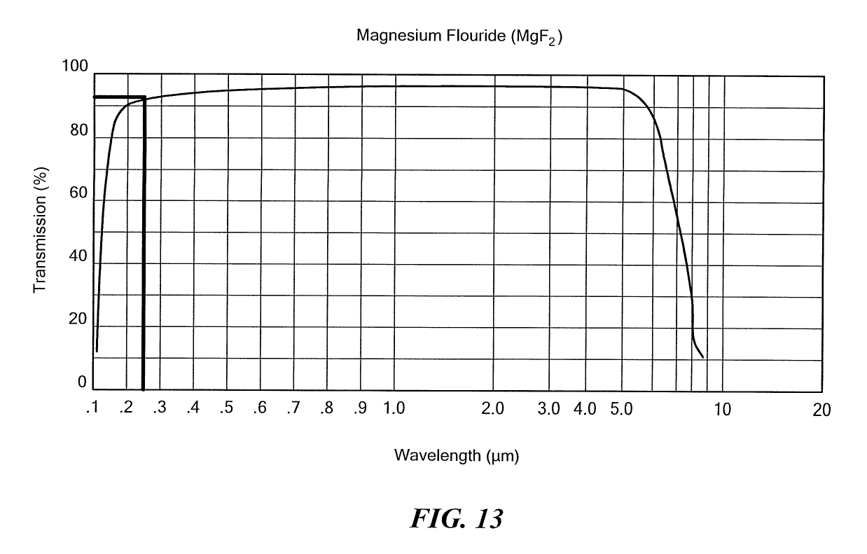

Referring now to FIG. 13, the graph corresponds to transmittance of magnesium fluoride. The transmittance of light at about 255 nm is greater than ninety percent.

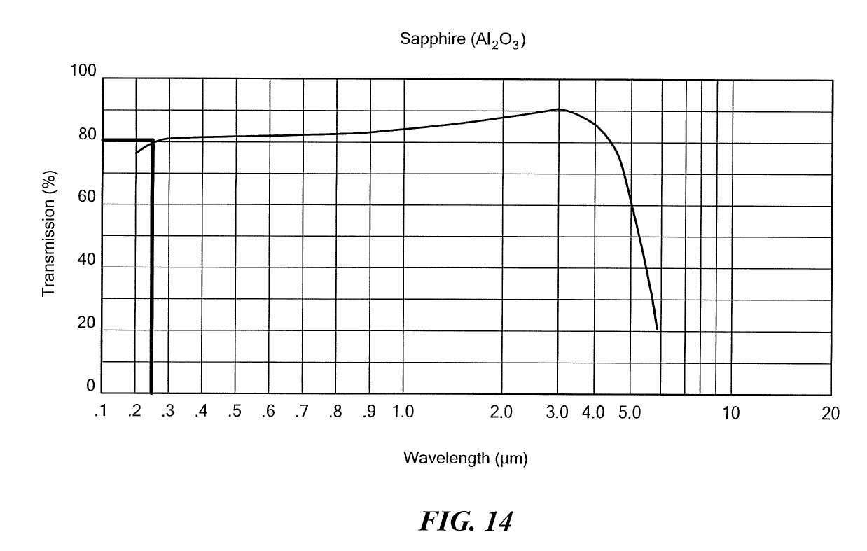

Referring now to FIG. 14, the graph corresponds to transmittance of sapphire. The transmittance of light at about 255 nm is about eighty percent.

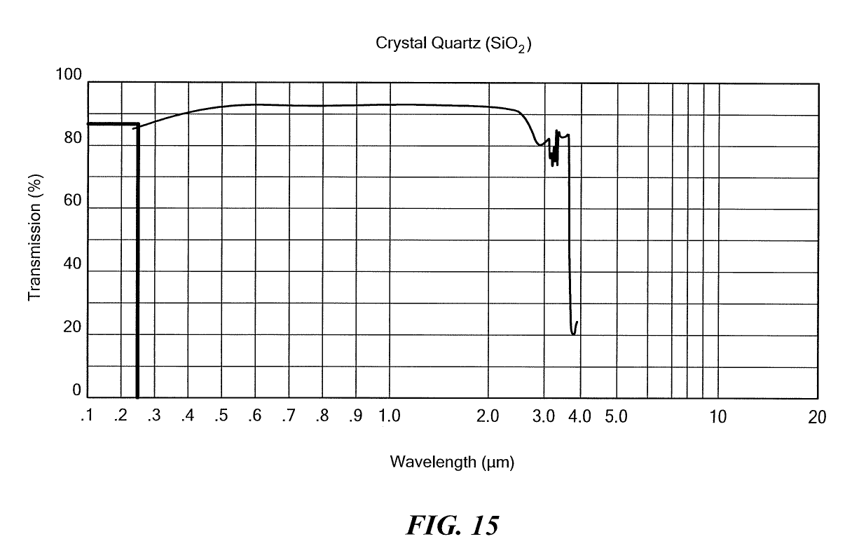

Referring now to FIG. 15, the graph corresponds to transmittance of crystal quartz. The transmittance of light at about 255 nm is about eighty-five percent.

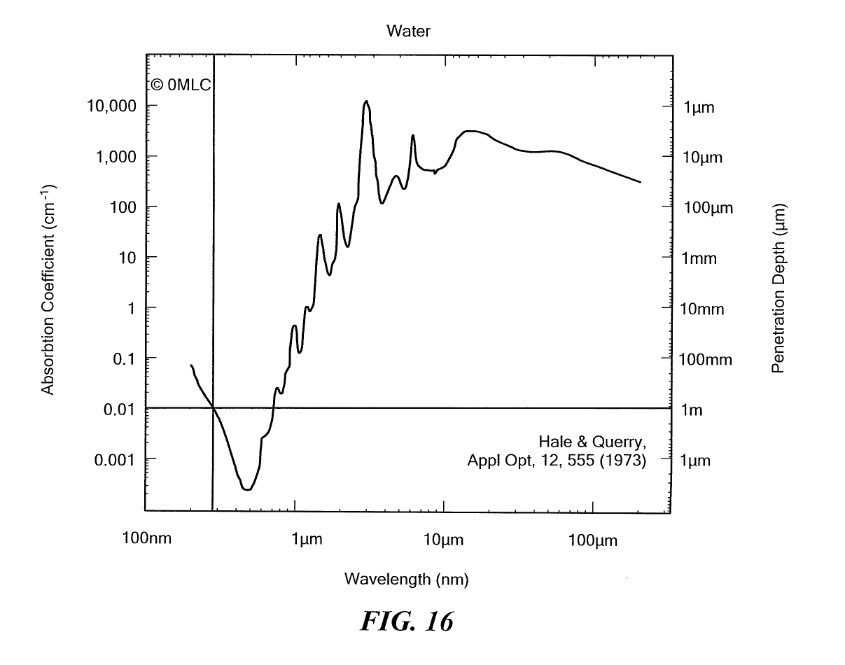

Referring now to FIG. 16, a graph has a horizontal axis with a scale in units of wavelength and a vertical axis with a scale in units of absorption coefficient in units of per centimeter in percent. A curve is representative of absorption of light in water. A vertical line at a wavelength of about 255 nm, representative of a wavelength of UVC light, intersects the curve at an absorption coefficient of about 0.01 per centimeter, which indicates that UVC light propagates well in water. However, it should be noted that longer wavelengths of light do not propagate well in water.

All references cited herein are hereby incorporated herein by reference in their entirety.

Having described preferred embodiments, which serve to illustrate various concepts, structures and techniques, which are the subject of this patent, it will now become apparent to those of ordinary skill in the art that other embodiments incorporating these concepts, structures and techniques may be used. Accordingly, it is submitted that that scope of the patent should not be limited to the described embodiments but rather should be limited only by the spirit and scope of the following claims.

What is claimed is:

1. Apparatus for imaging, comprising:
a pressure vessel having a port passing through the pressure vessel;
an optics window covering the port; and
an ultraviolet light source disposed inside the pressure vessel and proximate to the optics window, wherein the ultraviolet light source is configured to generate ultraviolet light that passes through the optics window and through the port, wherein the ultraviolet light has a wavelength selected to kill or repel biological organisms outside of the pressure vessel proximate to the optics window.

2. The apparatus of claim 1, wherein the ultraviolet light source comprises one or more light emitting diodes configured to emit the ultraviolet light.

3. The apparatus of claim 1, wherein the ultraviolet light source comprises one or more mercury vapor lamps configured to emit the ultraviolet light.

4. The apparatus of claim 1, wherein the ultraviolet light source comprises one or more lasers configured to emit the ultraviolet light.

5. The apparatus of claim 1, further comprising:
an imaging assembly disposed inside the pressure vessel and configured to generate an image of subject matter outside of the pressure vessel through the optics window and through the port.

6. The apparatus of claim 5, wherein the imaging assembly comprises:
a laser line scanning system configured to transmit or receive imaging light through the optics window and through the port.

7. The apparatus of claim 5, wherein the imaging assembly comprises:
a video camera.

8. The apparatus of claim 5, wherein the imaging assembly comprises:
a digital camera.

9. The apparatus of claim 5, further comprising:
a processor coupled to the ultraviolet light source and configured to control a duty cycle of the ultraviolet light.

10. The apparatus of claim 1, further comprising:
a processor coupled to the ultraviolet light source and configured to control a duty cycle of the ultraviolet light.

11. The apparatus of claim 1, wherein the ultraviolet light has a wavelength in the range of about 240 to about 260 nanometers.

11. The apparatus of claim 1, further comprising:
an imaging assembly disposed inside the pressure vessel for generating an optical image through the port, wherein the imaging assembly comprises:
a imaging camera configured to generate image data; and
an imaging processor coupled to receive the image data and configured to generate an image of subject matter outside of the pressure vessel through the optics window and through the port;

13. The apparatus of claim 12, wherein the imaging assembly further comprises:
an image recognition processor coupled to receive the image and configured to identify a signal representative of a characteristic of the image; and
a detection processor coupled to receive the signal representative of a characteristic of the image and configured to generate data associated with the characteristic.

14. The apparatus of claim 13, wherein the characteristic of the image comprises a count of objects in the image and the data associated with the characteristic comprises an accumulated count of the objects.

15. The apparatus of claim 13, wherein the characteristic of the image comprises a type of the subject matter in the image and the data associated with the image comprises an alarm message associated with the type of the subject matter.

16. A method of imaging, comprising:
generating ultraviolet light inside of a pressure vessel that passes through an optics window and through a port passing through the pressure vessel, wherein the ultraviolet light has a wavelength selected to kill or repel biological organisms outside of the pressure vessel proximate to the optics window.

17. The method of claim 16, wherein the generating the ultraviolet light comprises generating the ultraviolet light with one or more light emitting diodes configured to emit the ultraviolet light.

18. The method of claim 16, wherein the generating the ultraviolet light comprises generating the ultraviolet light with one or more mercury vapor lamps configured to emit the ultraviolet light.

19. The method of claim 16, wherein the generating the ultraviolet light comprises generating the ultraviolet light with one or more lasers configured to emit the ultraviolet light.

20. The method of claim 16, further comprising:
generating an image of subject matter outside of the pressure vessel through the optics window and through the port.

21. The method of claim 20, wherein generating the image comprises:
transmitting or receiving imaging light through the optics window and through the port with a laser line scanning system.

22. The method of claim 20, wherein generating the image comprises:
receiving imaging light through the optics window and through the port with a video camera.

23. The method of claim 20, wherein generating the image comprises:
receiving imaging light through the optics window and through the port with a digital camera.

24. The method of claim 20, further comprising:
controlling a duty cycle of the ultraviolet light.

25. The method of claim 16, further comprising:
controlling a duty cycle of the ultraviolet light.

26. The method of claim 16, wherein the ultraviolet light has a wavelength in the range of about 240 to about 260 nanometers.

27. The method of claim 16, further comprising:
generating an optical image through the port, wherein the generating the optical image comprises:
generating image data; and
from the image data, generating an image of subject matter outside of the pressure vessel through the optics window and through the port.

28. The method of claim 27, further comprising:
generating a signal representative of a characteristic of the image; and
generating data associated with the characteristic.

29. The method of claim 28, wherein the characteristic of the image comprises a count of objects in the image and the data associated with the characteristic comprises an accumulated count of the objects.

30. The method of claim 28, wherein the characteristic of the image comprises a type of the subject matter in the image and the data associated with the image comprises an alarm message associated with the type of the subject matter.
